(19) United States
(12) Patent Application Publication
(10) Pub. No.: US 2012/0022794 A1
(43) Pub. Date: Jan. 26, 2012

(54) Turbidity Measuring Device

(75) Inventors: Edin Andelic, Stuttgart (DE); Rudiger Frank, Haigerloch (DE)

(73) Assignee: Endress + Hauser Conducta Gellschaft fur Mess- und Regeltechnik mbH + Co. KG, Gerlingen (DE)

(21) Appl. No.: 13/260,398

(22) PCT Filed: Mar. 15, 2010
(86) PCT No.: PCT/EP2010/053269

§ 371 Date: Sep. 26, 2011

(30) Foreign Application Priority Data
Mar. 27, 2009 (DE) 10 2009 001 929.4

(51) Int. Cl. G06F 19/00

(52) U.S. Cl. 702/23

(57) ABSTRACT

A turbidity measuring device for determining the concentration Kⱼ of a substance Sⱼ in a medium includes measuring arrangements, in which the intensities of scattered light at different angles are registered and convertable into current values of at least a first measured variable M₁ and a second measured variable M₂, which have different dependences on the concentration Kⱼ of a substance Sⱼ (Mᵢ(Kⱼ)=fᵢ^{j}(Kⱼ)). The turbidity measuring device has stored for the measured variables Mᵢ for a number of substances Sⱼ calibration functions gᵢ^{j}, with which, in each case, a concentration of a substance Sⱼ is determinable (Kⱼ=gᵢ^{j}(Mᵢ)). The turbidity measuring device further includes a computing unit, which is suitable for evaluating the ascertained concentration values gₐ^{j}(Mₐ), g_{b}^{j}(M_{b}), wherein a≠b, for different substances Sⱼ as regards their plausibility and so to identify a plausible substance Sⱼ, or to check the plausibility of an earlier identified or predetermined substance Sⱼ.

The present invention relates to a turbidity measuring device for determining the concentration of substances, especially solids, colloids or gas bubbles, in a liquid.

In turbidity measurement, in-radiated light is scattered and the intensity of the light scattered at a first angle is compared with a reference variable, wherein the reference variable can be, for example, the intensity of unscattered light or the intensity of the light scattered at a second angle. Conventional turbidity measuring devices work, for example, according to the so-called four beam, alternating light method. An embodiment thereof is described in U.S. Pat. No. 5,140,168 A. Turbidity measuring devices using the four beam, alternating light method are available from the assignee, for example, under the mark/designation TURBIMAX CUS65.

Such method is, as regards ascertaining the measured value of concentration of a substance in a liquid under the assumption of otherwise constant conditions, over determined, since the value can be practically doubly ascertained. In the case of deviations between the measurement results in the case of the double measured value determination, the four beam, alternating light can be used to identify changes in the form of fouling of windows in the beam path of the measuring arrangement.

The present invention is based on the observation that the angular dependence of the intensity of the scattered light varies between different substances. In accordance therewith, a measuring arrangement is to be calibrated, in each case, for a determined substance. This means for a user a large effort at start-up or a lack of flexibility, when, for example, the concentration of another substance is to be measured.

It is, therefore, an object of the present invention to provide a turbidity measuring device and a method for determining concentration of a substance by means of turbidity measurement, which overcomes the disadvantages of the state of the art. The object is achieved according to the invention by the turbidity measuring device as defined in claim 1 and the method as defined in claim 8.

The turbidity measuring device of the invention includes for determining the concentration Kⱼ of a substance Sⱼ in a medium:

A first measuring arrangement, in which at least the intensity of scattered light at least a first angle is registered and convertable into a current value of a first measured variable M₁,
at least a second measuring arrangement, in which at least the intensity of scattered light at least a second angle, which is different from the first angle, is registered and convertable into a current value of a second measured variable M₂, wherein the measured variables Mᵢ (i=1, 2, . . . ) have different dependences on concentration Kⱼ of a substance Sⱼ (Mᵢ(Kⱼ)=fᵢ^{j}(Kⱼ)), wherein the turbidity measuring device has stored for the measured variables Mᵢ for at least two substances Sⱼ calibration functions gᵢ^{j}, with which, based on the current value Mᵢ, in each case, a suitable concentration of a substance Sⱼ is determinable (Kⱼ=gᵢ^{j}(Mᵢ)),
wherein the turbidity measuring device further includes a computing unit, which is suitable for evaluating the ascertained concentration values gₐ^{j}(Mₐ), g_{b}^{j}(M_{b}), wherein a≠b, for different substances Sⱼ as regards their plausibility and so to identify a plausible substance Sⱼ, or to check the plausibility of an earlier identified or predetermined substance Sⱼ.

In a further development of the invention, the first measured variable is a function of at least two light intensities, which are registered via a first and a second optical path, and the second measured variable is a function of at least two measured light intensities, which are registered via a third and a fourth path.

In a further development of the invention, the first measured variable is based on four beam, alternating light intensities in a first configuration and the second measured variable is based on four beam, alternating light intensities in a second configuration given, wherein the first configuration differs from the second configuration as regards one or a plurality of scattering angles.

In an embodiment of this further development of the invention, the first configuration includes a first light source and a second light source and a first receiver and a second receiver, wherein the optical path of the first light source to the first receiver and the optical path of the second light source to the second receiver, in each case, includes a light scattering at a first angle, which, for example, has a value between 120° and 150°, especially between 130° and 140° Furthermore, according to this embodiment of the invention, the second configuration includes the first light source and the second light source and a third receiver and a fourth receiver, wherein the optical path of the first light source to the third receiver and the optical path of the second light source to the fourth receiver, in each case, includes a light scattering at a second angle, which is different from the first angle, and has, for example, a value between 80° and 100°, especially between 85° and 95°.

In a variant of this embodiment of the invention, the optical path extends from the first light source to the first receiver essentially parallel to the optical path of the second light source to the second receiver and the optical path from the first light source to the third receiver runs parallel to the optical path of the second light source to the fourth receiver. These optical paths are referred to in the following also as direct optical paths. To be distinguished therefrom are so-called indirect paths, in the case of which the light of a light source reaches the receiver of the parallel optical path, thus from the first light source to the second receiver, or to the fourth receiver and from the second light source to the first receiver, or to the third receiver.

The first measured variable is then, for example, the product of the received intensities of the direct optical paths with the first scattering angle divided by the product of the received intensities of the corresponding indirect paths. The second measured variable is, following this approach, the product of the received intensities of the direct optical paths with the second scattering angle divided by the product of the received intensities of the corresponding indirect paths.

Due to the different angular dependences of the scattering behavior for different substances, the integral of the square of the difference between the ascertained concentration K of a substance S due to the current value of a measured variable Mₐ and the current value of a measured variable M_{b}

$${\int }_{0}^{{K}_{j}^{max}} {( {g}_{a}^{l} ( {M}_{a} ) - {g}_{b}^{l} ( {M}_{b} ) )}^{2} d {K}_{j} = {\int }_{0}^{{K}_{j}^{max}} {( {g}_{a}^{l} ( {f}_{a}^{j} ( {K}_{j} ) ) - {g}_{b}^{l} ( {f}_{b}^{j} ( {K}_{j} ) ) )}^{2} d {K}_{j}$$

has the smallest value, when the substance Sₗ assumed in the case of the calculating of the concentration values Kₗ(Mₐ) and Kₗ(M_{b}) actually agrees with the substance Sⱼ, which has effected the turbidity of the medium, when thus the right calibration models Kⱼ=gᵢ^{j}(Mᵢ) are assumed.

At a measuring point in a running process, without interventions in the process, there is scarcely the opportunity, to register the integral between the minimum concentration and the maximal concentration within a realistic deadline.

In a further development of the invention, a computing unit of the turbidity measuring device is provided to identify, especially in measurement operation, based on comparing the current, time averaged, summed, integrated or otherwise statistically evaluated deviation between gₐ^{l}(Mₐ(t)) and g_{b}^{l}(M_{b}(t)) for different substances S₁, that substance Sⱼ, which, as cause of the turbidity, has effected the values of the measured variables Mₐ and M_{b}.

In another further development of the invention, a computing unit of the turbidity measuring device is provided to check, especially in measurement operation, in the case of predetermined substance Sₗ, based on the current, time averaged, summed, integrated or otherwise statistically evaluated deviation between gₐ^{l}(Mₐ(t)) and g_{b}^{l}(M_{b}(t)), whether the predetermined or earlier identified substance Sₗ actually still is plausible as cause of the turbidity, which has effected the values of the measured variables Mₐ(t) and M_{b}(t).

The statistical evaluation can comprise, for example, the integral or the sum of the difference squares [gₐ^{l}(Mₐ(t))−g_{b}^{l}(M_{b}(t))]² over a time interval, which extends, for example, from t_{current}−Δt to t_{current}, wherein t_{current} is the current time and Δt the length of the time interval taken into consideration:

$${D}_{l} ( t ) := {\int }_{{t}_{current} - Δ t}^{{t}_{current}} {( {g}_{a}^{l} ( {M}_{a} ( t ) ) - {g}_{b}^{l} ( {M}_{b} ( t ) ) )}^{2} d t$$

$$or$$

$${D}_{l} ( t ) := \frac{1}{N} \cdot {\sum }_{i = 0}^{N - 1} {( {g}_{a}^{l} ( {M}_{a} ( {t}_{current} - i \cdot \frac{Δ t}{N} ) ) - {g}_{b}^{l} ( {M}_{b} ( {t}_{current} - i \cdot \frac{Δ t}{N} ) ) )}^{2}$$

Dₗ(t) is then an indicator for the deviation of the ascertained concentrations and the greater Dₗ(t), the smaller is the plausibility that Sₗ is the correct substance.

The method of the invention for determining the concentration Kⱼ of a substance Sⱼ in a medium includes steps as follows:

Determining a current value of a first measured variable M₁, which depends on the intensity of light scattered in the medium at least a first angle in a medium,
determining a current value of a second measured variable M₂, which depends at least on the intensity of light scattered in the medium at least a second angle, which is different from the first angle,
wherein the measured variables Mᵢ have different dependencies on the concentration Kⱼ of a substance Sⱼ (Mᵢ(Kⱼ)=fᵢ^{j}(Kⱼ)),
wherein, based on calibration functions gᵢ^{j}, which are available for the measured variables Mᵢ for at least two substances Sⱼ, concentration values Kⱼ=gᵢ^{j}(Mᵢ) are ascertained,
wherein the ascertained concentration values gₐ^{j}(Mₐ), g_{b}^{j}(M_{b}) are evaluated as regards their plausibility and so a plausible substance Sⱼ is identified, or the plausibility of an earlier identified or predetermined substance is checked.

In a further development of the method of the invention, the first measured variable is a function of at least two light intensities, which are registered via a first and a second optical path, wherein the second measured variable is a function of at least two measured light intensities, which are registered via a third and a fourth path.

In a further development of the method of the invention, the first measured variable is determined based on four beam, alternating light intensities in a first configuration, and the second measured variable is determined based on four beam, alternating light intensities in a second configuration, wherein the first configuration differs from the second configuration as regards one or a plurality of scattering angles.

In a further development of the method of the invention, based on comparing the current, time averaged, summed, integrated or otherwise statistically evaluated deviation between gₐ^{l}(Mₐ(t)) and g_{b}^{l}(M_{b}(t)) for different substances Sₗ, the substance Sⱼ is identified, which, as cause of the turbidity, has effected the values of the measured variables Mₐ and M_{b}.

In another further development of the method of the invention, in the case of predetermined substance Sₗ, based on the current, time averaged, summed, integrated or otherwise statistically evaluated deviation between gₐ^{l}(Mₐ(t)) and g_{b}^{l}(M_{b}(t)), it is checked whether the predetermined or earlier identified substance S₁ actually is still plausible as the cause of the turbidity, which has effected the values of the measured variables Mₐ(t) and M_{b}(t).

The invention will now be explained based on the examples of embodiments presented in the drawing, the figures of which show as follows:

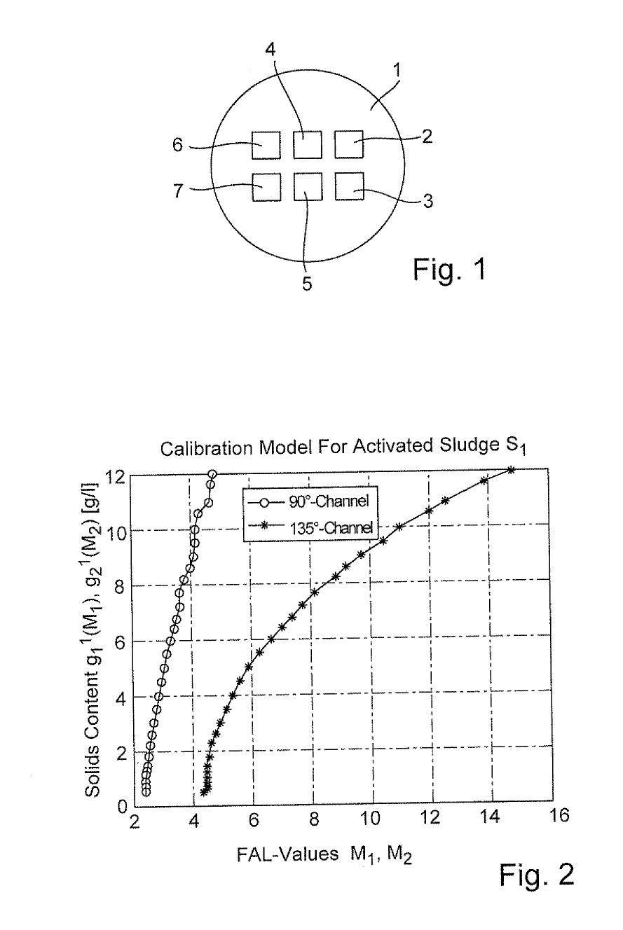

FIG. 1 a plan view of a sensor surface of a turbidity measuring device of the invention;

FIG. 2 examples of calibration curves for the solids content of activated sludge as a function of measured variables using the four beam, alternating light principle.

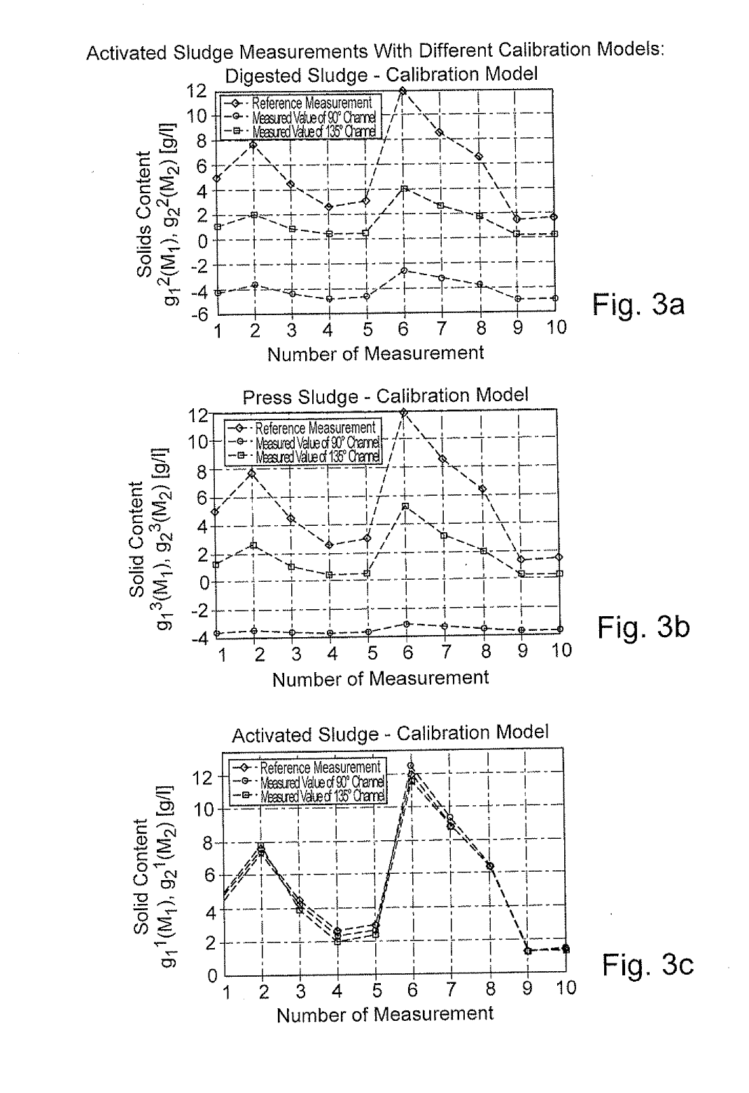

FIGS. 3a-c solids content based on measurement data of measurements in activated sludge with application of various calibration models, wherein, supplementally, the result of a reference measurement is given, the calibration models being:
a: Digested sludge calibration model
b: Press sludge calibration model
c: Activated sludge calibration model;

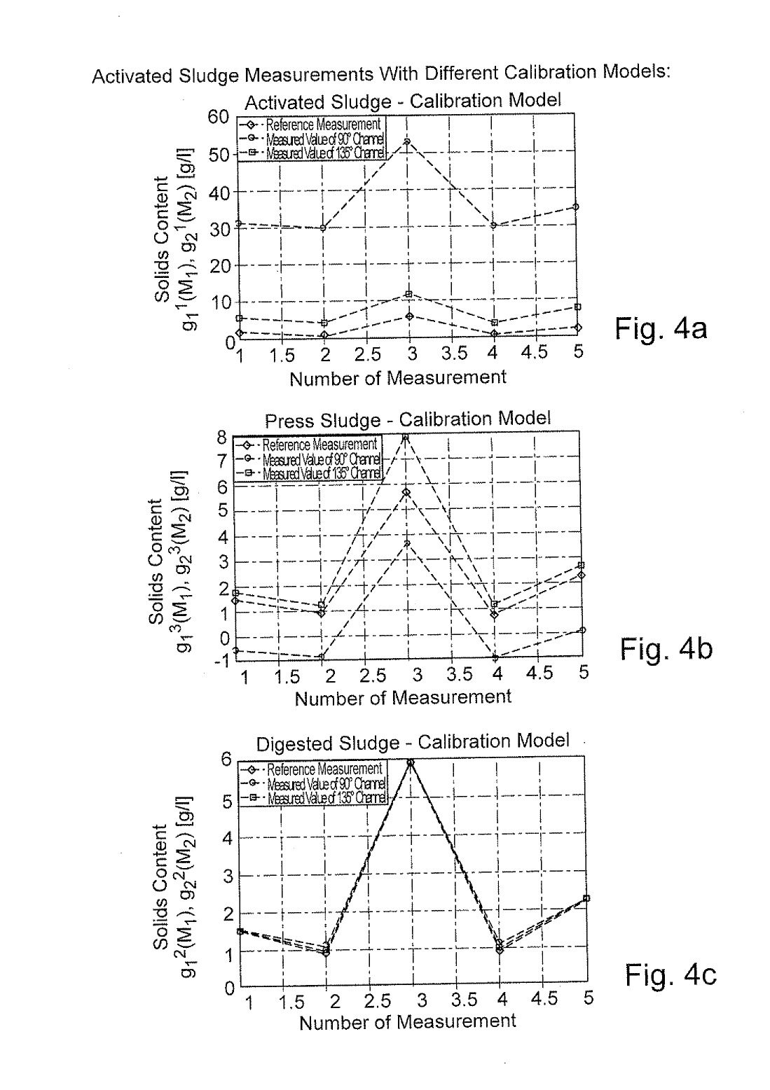

FIGS. 4a-c solids content based on measurement data of measurements in digested sludge with application of various calibration models, wherein, supplementally, the result of a reference measurement is given, the calibration models being:
a: Activated sludge calibration model
b: Press sludge calibration model
c: Digested sludge calibration model; and

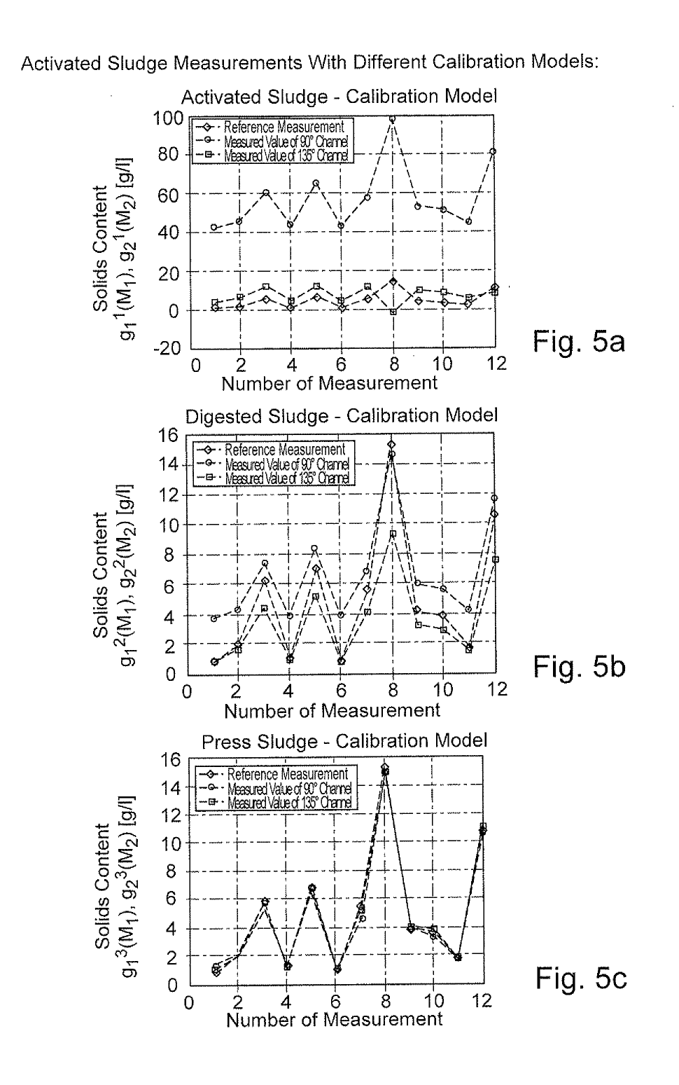

FIGS. 5a-c solids content based on measurement data of measurements in press sludge with application of various calibration models, wherein, supplementally, the result a reference measurement is given, the calibration models being:
a: Activated sludge calibration model
b: Digested sludge calibration model
c: Press sludge calibration model.

The end face of a turbidity sensor shown in FIG. 1 includes an exit window (2) of a first light source, an exit window (3) of a second light source, an entrance window (4) of a first receiver, an entrance window (5) of a second receiver, an entrance window (6) of a third receiver and an entrance window (7) of a fourth receiver. The windows of the first light source (2), the first receiver (4) and the third receiver (6) are arranged in a first row, while the windows of the second light source (3), the second receiver (5) and the fourth receiver (7) are arranged in a second row, which extends parallel to the first row. The light of the light sources is emitted with an optical axis at an angle of 45 degree to the end face of the turbidity sensor, wherein the projection of the optical axis of the light emitted from the first light source on the end face of the turbidity sensor housing aligns with the first row, and wherein the projection of the optical axis of the light emitted from the second light source (3) on the end face of the turbidity sensor housing aligns with the second row.

Light emitted from the first light source reaches by scattering at an angle of 135 degree the first receiver and by scattering at a second angle of 90 degree the third receiver, while, correspondingly, reaches light from the second light source (3) by scattering at the first angle of 135 degree reaches the second receiver (5) and by scattering at the second angle of 90 degree the fourth receiver (7). The just described measuring paths extending, in each case, within a row from a transmitter to one of the receivers are the so-called direct measuring paths. To be distinguished therefrom are the indirect measuring paths, in the case of which light of the light source from one row reaches by scattering a detector in the other row.

In the example of an embodiment of the turbidity measuring device of the invention, two measured variables are ascertained, which, in each case, occur using four beam, alternating light measurement and evaluation of the direct and indirect paths to the receivers for scattering at 90 degree, and to the receivers for scattering at 35 degree.

Therewith result the following definitions for the measured variables:

M₁:=(L1_{—}R1*L2_{—}R2)/(L1_{—}R2*L2_{—}R1) and

M₂:=(L1_{—}R3*L2_{—}R4)/(L1_{—}R4*L2_{—}R3),

wherein Li_Rj is the intensity of the light from the i-th light source reaching the j-th receiver.

The measured variable M₁ relates accordingly to the so-called 90 degree channel, while the measured variable M₂ relates to the so called 135 degree channel.

FIG. 2 shows an example of a calibration curve for activated sludge for the 90 degree channel and for the 135 degree channel, wherein the solids content in g/l is plotted versus the ascertained four beam, alternating light (FAL) measured variable. These calibration curves correspond to functions g₁¹ (M₁) and g₂¹(m₂), wherein, in this case, the substance S₁ is activated sludge.

These curves are stored either as value tables or as functional relationships, so that they are available to the computing unit of the turbidity measuring device for the evaluation. Corresponding calibration models for digested sludge g₁² of M₁ and g₂² of M₂ as well as for press sludge g₁³ of M₁ and g₂³ of M₂ are likewise stored.

FIGS. 3 to 5 show the results of measurement series with different substances, namely activated sludge, digested sludge and press sludge, wherein, in the sub figures a to c, the evaluations of the measurement data with the different calibration models are presented.

Fig. c in the series shows, in each case, application of the appropriate calibration model, wherein it is clear that with this an excellent agreement of the results of the 90 degree channel and the 135 degree channel with one another and with an independent reference can be achieved, while the ascertained solids contents with the, in each case, other calibration models deliver unacceptable results.

Therewith, it is directly possible, through applications of the different calibration models and through comparison of the therewith achieved agreement between the results for the two measurement channels, to identify the right calibration model and the right substance.

The named angles are, of course, selected only by way of example and the apparatus can also be constructed with application of other scattering angles and, in given cases, other light sources, or receivers, in order to define other measured variables M₃, M₄, . . . .

Equally, a four beam, alternating light arrangement of the described type can be constructed with, in each case, one receiver in a row and two light sources in the row.

1-12. (canceled)

13. A turbidity measuring device for determining the concentration Kⱼ of a substance Sⱼ in a medium, comprising:
a first measuring arrangement, in which at least the intensity of scattered light at least a first angle is registered and convertable into a current value of a first measured variable M₁,
at least a second measuring arrangement, in which at least the intensity of scattered light at least a second angle, which is different from said first angle, is registered and convertable into a current value of a second measured variable, wherein said measured variables Mᵢ (i=1,2, . . . ) have different dependencies on the concentration Kⱼ of the substance Sⱼ (Mᵢ(Kⱼ)=fᵢ^{j}(Kⱼ)), and wherein the turbidity measuring device has stored for the measured variables Mᵢ for at least two substances Sⱼ calibration functions gᵢ^{j}, with which, based on the current value Mᵢ, in each case, a suitable concentration of a substance Sⱼ is determinable (Kⱼ=gᵢ^{j}(Mᵢ)); and
a computing unit, which is suitable for evaluating the ascertained concentration values gₐ^{j}(Mₐ), g_{b}^{j}(M_{b}), wherein a≠b, for different substances Sⱼ as regards their plausibility and so to identify a plausible substance Sⱼ, or to check the plausibility of an earlier identified or predetermined substance Sⱼ.

14. The turbidity measuring device as claimed in claim 13, wherein:
said first measured variable is a function of at least two light intensities, which are registered via a first and a second optical path, and
said second measured variable is a function of at least two measured light intensities, which are registered via a third and a fourth path.

15. The turbidity measuring device as claimed in claim 14, wherein:
said first measured variable is based on four beam, alternating light intensities in a first configuration and said second measured variable is based on four beam, alternating light intensities in a second configuration; and
said first configuration differs from said second configuration as regards one or a plurality of scattering angles.

16. The turbidity measuring device as claimed in claim 15, wherein:
said first configuration has a first light source, a second light source, a first receiver and a second receiver;
the optical path of said first light source to said first receiver extends essentially parallel to the optical path of said second light source to said second receiver; and
the optical axis of the two optical paths includes a light scattering at a first angle, which, for example, comprises a value between 120° and 150°, especially between 130° and 140°.

17. The turbidity measuring device as claimed in claim 16, wherein:
said second configuration has the first light source, said second light source, a third receiver and a fourth receiver;
the optical path of said first light source to said third receiver extends essentially parallel to the optical path of said second light source to said fourth receiver; and
the optical axis of the two optical paths includes a light scattering at a second angle, which differs from the first angle, and, for example, comprises a value between 80° and 100°, especially between 85° and 95°.

18. The turbidity measuring device as claimed in claim 13, wherein:
said computing unit is provided, based on comparing the current, time averaged, summed, integrated or otherwise statistically evaluated deviation between gₐ^{l}(Mₐ(t)) and g_{b}^{l}(M_{b}(t)) for different substances Sₗ, to identify that substance Sⱼ, which, as a cause of the turbidity, has effected the values of the measured variables Mₐ and M_{b}.

19. The turbidity measuring device as claimed in claim 13, wherein:
said computing unit is provided, in the case of predetermined substance Sₗ, based on current, time averaged, summed, integrated or otherwise statistically evaluated deviation between gₐ^{l}(Mₐ(t)) and g_{b}^{l}(M_{b}(t)), to check whether the predetermined or earlier identified substance Sₗ is actually still plausible as cause of the turbidity, which has effected the values of the measured variables Mₐ(t) and M_{b}(t).

20. A method for determining the concentration Kⱼ of a substance Sⱼ in a medium, comprising the steps of:
determining a current value of a first measured variable M₁, which depends on the intensity of light scattered in the medium at least a first angle in a medium; and
determining a current value of a second measured variable M₂, which depends at least on the intensity of light scattered in the medium at least a second angle, which is different from the first angle, wherein:
the measured variables Mᵢ have different dependencies on the concentration Kⱼ of a substance Sⱼ (Mᵢ(Kⱼ)=fᵢ^{j}(Kⱼ));
based on calibration functions gᵢ^{j}, which are available for the measured variables Mᵢ for at least two substances Sⱼ, concentration values Kⱼ=gᵢ^{j}(Mᵢ) are ascertained; and
the ascertained concentration values gₐ^{j}(Mₐ), g_{b}^{j}(M_{b}) are evaluated as regards their plausibility and so a plausible substance Sⱼ is identified, or the plausibility of an earlier identified or predetermined substance is checked.

21. The method as claimed in claim 20, wherein:
the first measured variable is a function of at least two light intensities, which are registered via a first and a second optical path; and
the second measured variable is a function of at least two measured light intensities, which are registered via a third and a fourth path.

22. The method as claimed in claim 20, wherein:
the first measured variable is based on four beam, alternating light intensities in a first configuration and the second measured variable is based on four beam, alternating light intensities in a second configuration; and
the first configuration differs from the second configuration as regards one or a plurality of scattering angles.

23. The method as claimed in claim 20, wherein:
based on comparing current, time averaged, summed, integrated or otherwise statistically evaluated deviation between gₐ^{l}(Mₐ(t)) and g_{b}^{l}(M_{b}(t)) for different substances Sₗ, that substance Sⱼ is identified, which, as cause of the turbidity, has effected the values of the measured variables Mₐ and M_{b}.

24. The method as claimed in claim 20, wherein:
in the case of a predetermined substance Sₗ, based on current, time averaged, summed, integrated or otherwise statistically evaluated deviation between gₐ^{l}(Mₐ(t)) and g_{b}^{l}(M_{b}(t)), it is checked whether the predetermined or earlier identified substance Sₗ is actually still plausible as cause of the turbidity, which has effected the values of the measured variables Mₐ(t) and M_{b}(t).
